(19) United States
(12) Patent Application Publication
(10) Pub. No.: US 2024/0319556 A1
(43) Pub. Date: Sep. 26, 2024

(54) TRANSPARENT ELASTIC ELECTRODE STACKS WITH LOW RESISTANCE

(71) Applicant: Gentex Corporation, Zeeland, MI (US)

(72) Inventors: Mario F. Saenger Nayver, Holland, MI (US); John S. Anderson, Holland, MI (US); Henry A. Luten, Zeeland, MI (US); Nestor Paul Murphy, Milford, MI (US)

(73) Assignee: Gentex Corporation, Zeeland, MI (US)

(21) Appl. No.: 18/613,494

(22) Filed: Mar. 22, 2024

Related U.S. Application Data
(60) Provisional application No. 63/454,476, filed on Mar. 24, 2023.

(51) Int. Cl. G02F 1/155; G02F 1/1343

(52) U.S. Cl. CPC G02F 1/155; G02F 1/13439

(57) ABSTRACT

An electro-optic assembly includes a first substrate that has a first surface and a second surface opposite the first surface. A second substrate has a third surface and a fourth surface opposite the third surface. The second and third surfaces face each other to define a gap. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

### CROSS-REFERENCE TO RELATED APPLICATION

This application claims priority to and the benefit under 35 U.S.C. § 119(e) of U.S. Provisional Application No. 63/454,476, filed on Mar. 24, 2023, entitled “TRANSPARENT ELASTIC ELECTRODE STACKS WITH LOW RESISTANCE,” the disclosure of which is hereby incorporated herein by reference in its entirety.

### FIELD OF THE DISCLOSURE

The present disclosure generally relates to a transparent elastic electrode stack with low resistance, and, more particularly, to an electro-optic assembly having a transparent elastic electrode stack with low resistance.

### SUMMARY OF THE DISCLOSURE

According to one aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to another aspect of the present disclosure, an electro-optic assembly includes a first substrate of a non-planar shape includes a first surface and a second surface opposite the first surface. A second substrate has the non-planar shape and includes a third surface and a fourth surface opposite the third surface. The second and third surfaces face each other to define a gap. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to yet another aspect of the present disclosure, an electro-optic assembly includes a first substrate of a non-planar shape having a first surface and a second surface opposite the first surface. A second substrate has the non-planar shape and includes a third surface and a fourth surface opposite the third surface. The second and third surfaces face each other to define a gap. The second and third surfaces each extend to an outer perimeter defining an area, respectively, and a non-planar shape defines at least 20% of the area. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to still yet another aspect of the present disclosure, an electro-optic preform roll includes a substrate and an electrode stack coupled to the substrate. The electrode stack includes a base layer, a conduction layer formed of a transparent conductive material, and a flexible conductive layer spaced from the base layer by the conduction layer. The flexible conductive layer is formed of an electrically conductive polymer.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electro-optic assembly that includes a pair of opposing electrode stacks in accordance with the present disclosure;

FIG. 2A is a top view of a vehicle incorporating an electro-optic assembly in accordance with the present disclosure;

FIG. 2B is an upper perspective view of an aircraft incorporating an electro-optic assembly in accordance with the present disclosure;

FIG. 2C is an elevational view of a building incorporating an electro-optic assembly in accordance with the present disclosure;

FIG. 2D is an upper perspective view of an eyewear assembly incorporating an electro-optic assembly in accordance with the present disclosure;

FIG. 3 is an enlarged cross-sectional view of an electrode stack of a first construction in accordance with the present disclosure;

FIG. 4 is an enlarged cross-sectional view of an electrode stack of a second construction in accordance with the present disclosure;

FIG. 5A is an upper perspective of an electro-optic preform roll in accordance with the present disclosure;

FIG. 5B is a cross-sectional view of an electro-optic assembly that has a non-planar shape; and

FIG. 6 is a flow chart illustrating a method of forming an electrode stack on a substrate.

### DETAILED DESCRIPTION

The present illustrated embodiments reside primarily in combinations of method steps and apparatus components related to an electro-optic assembly having a transparent elastic electrode stack with low resistance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

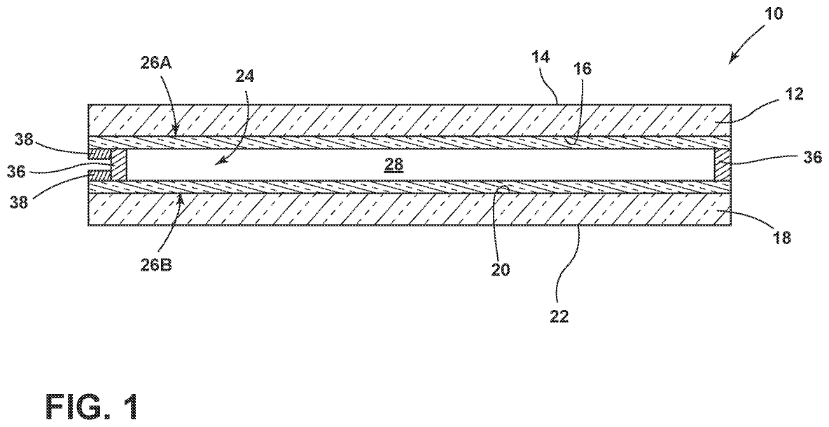

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

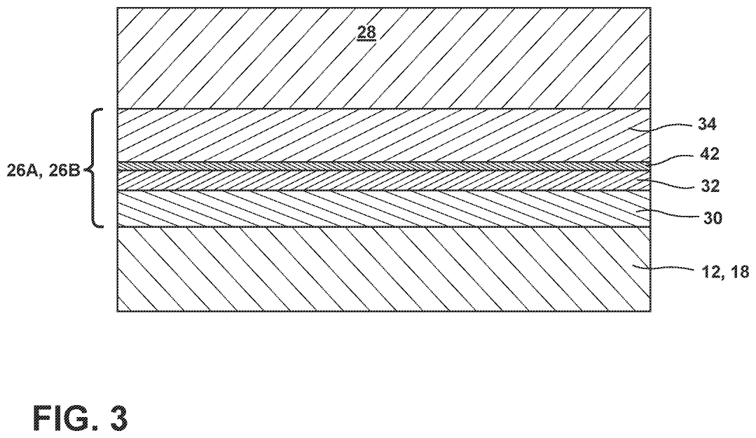

Referring to FIGS. 1-4, reference numeral 10 generally designates an electro-optic assembly. The electro-optic assembly 10 includes a first substrate 12 that has a first surface 14 and a second surface 16 opposite the first surface 14. A second substrate 18 has a third surface 20 and a fourth surface 22 opposite the third surface 20, the second and third surfaces 16, 20 face each other to define a gap 24. A first electrode stack 26A is coupled to the second surface 16, and a second electrode stack 26B is coupled to the third surface 20. An electro-optic medium 28 is located between the first electrode stack 26A and the second electrode stack 26B. At least one of the first and second electrode stacks 26A, 26B includes a base layer 30, a conduction layer 32 formed of a transparent conductive material, and a flexible conductive layer 34 spaced from the base layer 30 by the conduction layer 32 (FIG. 3). The flexible conductive layer 34 is formed of an electrically conductive polymer. For example, the flexible conductive layer 34 may be formed of a polythiophene, such as poly(3,4-ethylenedioxythiophene) (“PEDOT”) or other polythiophenes.

With continued reference to FIGS. 1-4, in some embodiments, both the first and second electrode stacks 26A, 26B include the base layer 30, the conduction layer 32 formed of a transparent conductive material, and the flexible conductive layer 34 formed of the electrically conductive polymer spaced from the base layer 30 by the conduction layer 32. In some embodiments, the first and second substrates 12, 18 may be formed of a flexible plastic material. In some embodiments, the electro-optic assembly may define non-planar shapes (e.g., concave, convex, combinations thereof, angles, and/or other non-planar shapes). In some embodiments, the flexible conductive layer 34 defines a thickness between about 40 nm to about 150 nm. In some embodiments, the conduction layer 32 defines a thickness between about 4 nm to about 20 nm. The flexible conductive layer 34 provides resilience against tensile stress. In this manner, in embodiments where the first and second substrates 12, 18 are formed of a flexible plastic material, greater resilience to tensile stress permits more flexibility without degradation of the first and second electrode stacks 26A, 26B. Likewise, in embodiments where the first and second substrates 12, 18 define non-planar shapes, conformity of the first and second electrode stacks 26A, 26B can be simplified by greater resilience to tensile stress. In this manner, the flexible conductive layer 34 can work with a variety of conduction layer 32 materials to bridge gaps formed as a result of stretching.

With reference now to FIG. 1, the electro-optic assembly 10 includes a seal 36 that retains the electro-optic medium 28 in an inboard direction. A pair of buses 38 may include a first bus electrically coupled to the first electrode stack 26A and a second bus electrically coupled to the second electrode stack 26B. In some embodiments, the first and second buses are directly adhered to opposing flexible conductive layers 34 and/or opposing conduction layers 32. The pair of buses 38 may each be formed of a flexible conductive material, such as a tape, foam, and/or the like to facilitate shaping the electro-optic assembly 10 into a variety of shapes.

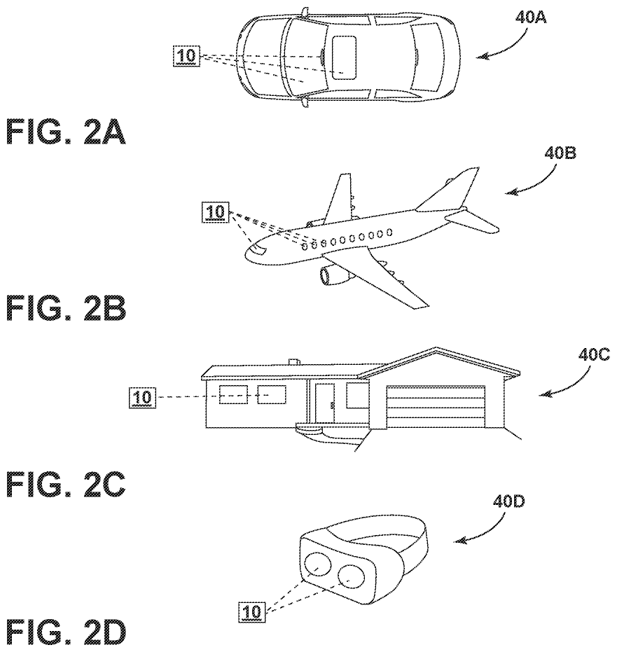

With reference now to FIGS. 2A-2D, the electro-optic assembly 10 may be configured as an electrochromic device that is switchable between a substantially transmissive state and a substantially darkened state. In other embodiments, the electro-optic assembly 10 is configured as an electrochromic device that is switchable between a high reflectance state and a low reflectance state. Various embodiments of electro-optic assembly 10 may be incorporated with one or more structures 40A-40C. For example, FIG. 2A illustrates an automobile 40A employing the electro-optic assembly 10, for example, with an interior rearview mirror, a sunroof, a windshield, a side window, a heads-up display, and/or other interior vehicle locations that display one or more aspects of the electro-optic assembly 10. The automobile 40A may include a commercial vehicle, an emergency vehicle, a residential vehicle, or the like. FIG. 2B illustrates an aircraft 40B employing the electro-optic assembly 10 (e.g., a front window, side window, heads-up display). FIG. 2C illustrates a building 40C employing electro-optic assembly 10 (e.g., a window). The building 40C may be a residential building, a commercial building, and/or the like. Generally speaking, the electro-optic assembly 10 may be incorporated into any environment where it is beneficial to change the state of a window, mirror, and/or display. FIG. 2D illustrates eyewear 40D employing electro-optic assembly 10. For example, the eyewear may be glass or plastic with dimming functionality and include augmented reality or virtual reality. Generally speaking, other structures, such as a heads-up display or other environments wherein electrochromic effects are beneficial, may employ the electro-optic assembly 10 with dimming functionality or augmented reality. Generally speaking, other structures, such as a heads-up display or other environments wherein a light dimming device with low reflectance is beneficial, may employ the electro-optic assembly 10.

With reference now to FIG. 3, a first construction of the first and/or second electrode stack 26A, 26B is illustrated. In the first construction, the base layer 30 is formed of material other than the electrically conductive polymer or polythiophene, which may include a conductive material or layer and/or an insulating material or layer. In some embodiments, the base layer 30 may comprise at least one of silicone dioxide (SiO₂), SiN, or variant, magnesium fluoride (MgF₂), and/or the like. The base layer 30 may be directly adhered to the second and third surfaces 16, 20. The conduction layer 32 may be directly adhered to the base layer 30. The conduction layer 32 is formed of the transparent conductive material and the transparent conductive material may include at least one of indium tin oxide (“ITO”), zinc oxide (“ZnO”), indium zinc oxide (“IZO”), copper material, other transparent conductive oxides (“TCO”), silver material, Silver alloy, or other conductive low index materials. The flexible conductive layer 34 may be directly adhered to the conduction layer 32 or an adhesion layer 42 may be disposed between the conduction layer 32 and the flexible conductive layer 34. For example, the adhesion layer 42 may include a metal or metal oxide. The flexible conductive layer 34 of the first electrode stack 26A and the second electrode stack 26B may define (e.g., with the seal 36) the gap 24 that contains the electro-optic medium 28.

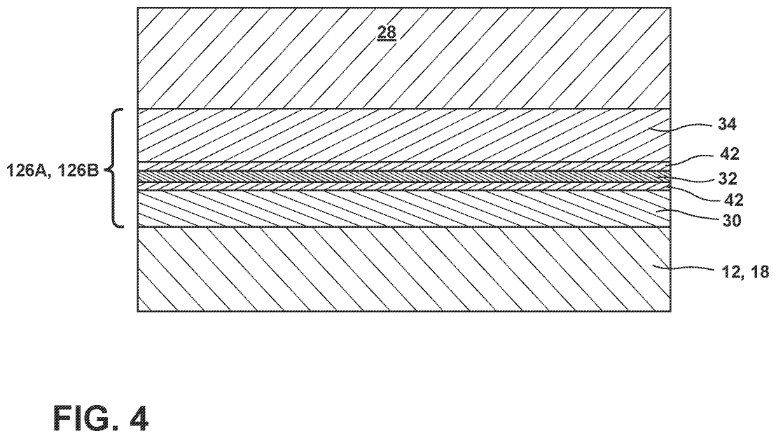

With reference now to FIG. 4, a second construction of the first and/or second electrode stack 126A, 126B is illustrated. Unless otherwise indicated, the second construction may share all of the same features, dimensions, functionalities, and be incorporated into the same structures as the first construction. However, in the second construction, the base layer 30 may be formed of the electrically conductive polymer material (e.g., a polythiophene such as PEDOT). In this manner, the adhesion layer 42 may include a plurality of adhesion layers 42, including an adhesion layer 42 between the base layer 30 and the conduction layer 32 and an adhesion layer 42 between the conduction layer 32 and the flexible conductive layer 34. In some embodiments, the plurality of adhesion layers 42 may include an adhesion layer 42 between the base layer 30 and the substrates 12, 18. The one or more adhesion layers 42 may adhere to and protect the conduction layer 32.

With reference now to FIGS. 3 and 4, the electrode stack 26A, 26B of the first construction and the electrode stack 126A, 126B of the second construction exhibit improvements in strain, thus aiding the formation of non-planar shapes. More particularly, when the base layer 30, the flexible conductive layer 34, and/or the conduction layer 32 are formed of the conductive polymer material (e.g., a polythiophene such as PEDOT) strain testing has shown improvement in stack tolerates about 8 times higher strain that a conventional electrode stack with having layers consisting of ITO/silver alloy/ITO. For example, when the base layer 30, the flexible conductive layer 34, and the conduction layer 32 are formed of the flexible polymer material, failure can occur at about 40% strain, while the conventional electrode stack experience failure at about 5% strain. For purposes herein, a 40% strain occurs when, for example, a segment of the electrode stack is 100 mm in length and gets pulled to 140 mm in length before exhibiting failure. The benefits in strain tolerance occur when only one or two of the base layer 30, the flexible conductive layer 34, and/or the conduction layer 32 are formed of the conductive polymer material.

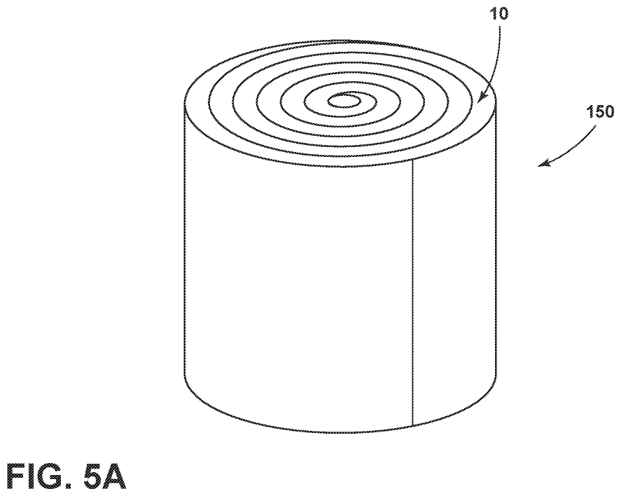

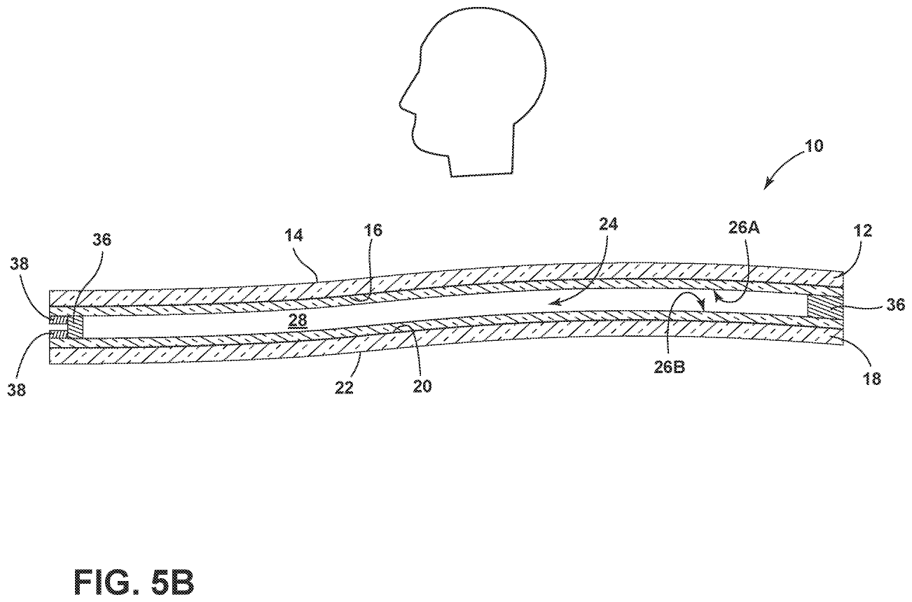

With reference now to FIG. 5A, the electro-optic assembly 10 or portions thereof may be formed into a roll 150. More particularly, the roll 150 may be stored until the electro-optic assembly 10 is shaped and sized for integration into the one or more structures 40A-40D. For example, during assembly of the electro-optic assembly 10, the roll 150 may be unrolled and bent and cut to size. In some embodiments, the roll 150 may include the electro-optic assembly 10 (e.g., components between the first surface 14 and the fourth surface 22). In some embodiments, the roll 150 may include one of the first and second substrates 12, 18 and an associated electrode stack 26A, 26B, 126A, 126B. The roll 150 may be pre-formed prior to shaping the electro-optic assembly 10 into a planar or non-planar shape.

With reference now to FIG. 5B, the electro-optic assembly 10 may generally have a non-planar shape when shaped and sized for integration into the one or more structures 40A-40D. More particularly, the first substrate 12 and the second substrate 18 may have the non-planar shape (i.e., contour). For example, the second and third surfaces 16, 20 may define the non-planar shape such that the gap 24, likewise, generally is defined by the non-planar shape. While the gap 24 may be defined by the non-planar shape, the cell spacing (e.g., the space between the second and third surfaces 16, 20) may be substantially uniform. In some embodiments, the first and fourth surfaces 14, 22 may, likewise, be defined by the non-planar shape. In some embodiments, the first substrate 12 defines a substantially uniform thickness and the second substrate 18 defines a substantially uniform thickness (e.g., pre-shaping and/or post-shaping). The first substrates 12 (e.g., and associated first and second surfaces 14, 16) and the second substrate 18 (e.g., the associated third and fourth surfaces 20, 22) each extend to an outer perimeter (O.P.) defining an area, respectively. The areas of both the first and second substrates 12, 18 may be equal. More particularly, the area may be defined by the second and third surfaces 16, 20 and/or the first and fourth surfaces 14, 22. In some embodiments, the non-planar shape defines at least 10% of the area. For example, at least 15%, at least 20%, at least 30%, at least 40%, at least 50%, at least 60%, at least 70%, at least 80%, or at least 90%. In this manner, it should be appreciated that the electro-optic assembly 10 can be shaped into a variety of different non-planar shapes or planar shapes dependent on which structure 40A-40D the electro-optic assembly 10 will be incorporated in. Further, it should be appreciated that because the substrates 12, 18 may be formed of plastic, the buses 38 may be flexible, and the layers in the different constructions of the first electrode stack 26A, 126A and second electrode stack 26B, 126B may be generally flexible (e.g., via a polythiophene such as PEDOT), the electro-optic assembly 10 can be shaped based on a variety of needs (e.g., post assembly, from the roll 150, combinations thereof, and/or the like).

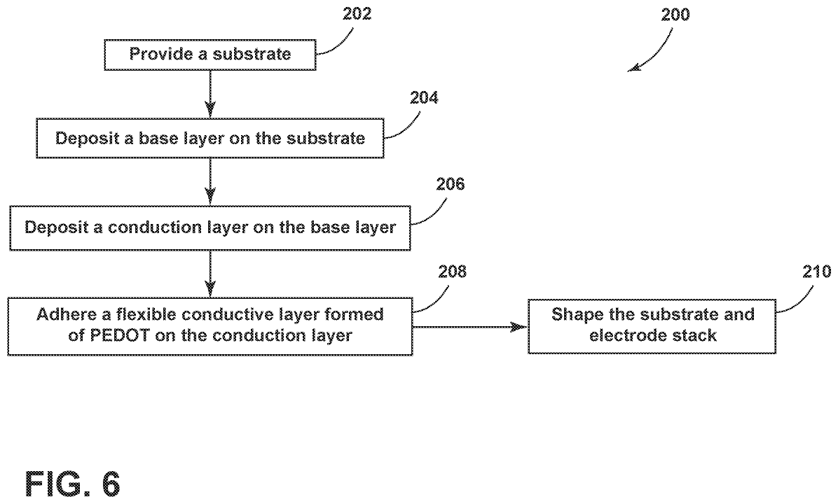

With reference now to FIG. 6, a method 200 of forming an electrode stack 26A, 26B on a substrate 12, 18 is illustrated. At 202, the method 200 includes providing a substrate 12, 18. The substrates 12, 18 may be formed of flexible plastic. At 204, the method 200 includes depositing a base layer 30 on the substrate 12, 18. The base layer 30 may be formed of an electrically conductive polymer (e.g., a polythiophene such as PEDOT), a different conductive material, or an insulating material. At 206, the method 200 includes depositing a conduction layer 32 on the base layer 30. The conduction layer 32 may be adhered to the base layer 30 with an adhesion layer 42, for example, formed of an oxide. At 208, a flexible conductive layer 34 (e.g., formed of an electrically conductive polymer, for example, a polythiophene such as PEDOT) is adhered to the conduction layer 32. For example, the flexible conductive layer 34 may be adhered to the conduction layer 32 with an adhesion layer 42, for example, formed of an oxide. The flexible conduction layer 32 may be vacuum sealed onto the conduction layer 32 (e.g., with the adhesion layer 42). At step 210, the substrates 12, 18 and electrode stacks 26A, 26B are shaped (e.g., into a roll 150 for later processing) or into a final shape before incorporating into one or more structures 40A-40D.

The disclosure herein is further summarized in the following paragraphs and is further characterized by combinations of any and all of the various aspects described therein.

According to one aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to another aspect, the flexible conductive layer is formed of a polythiophene.

According to another aspect, an electro-optic assembly includes a base layer if formed of a polythiophene.

According to another aspect, an electro-optic assembly includes an adhesion layer disposed between a conduction layer and a flexible conductive layer.

According to yet another aspect, an adhesion layer includes an oxide.

According to still another aspect, an electro-optic assembly includes a base layer that is conductive.

According to another aspect, an electro-optic assembly includes a base layer having an insulating layer.

According to yet another aspect, a first and second substrate are non-planar.

According to still another aspect, a conduction layer is sandwiched between a pair of adhesion layers that adhere and protect the conduction layer.

According to another aspect, a pair of adhesion layers are formed of a metal oxide.

According to another aspect of the present disclosure, an electro-optic assembly includes a first substrate of a non-planar shape includes a first surface and a second surface opposite the first surface. A second substrate has the non-planar shape and includes a third surface and a fourth surface opposite the third surface. The second and third surfaces face each other to define a gap. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to another aspect, second and third surfaces are each defined by a non-planar shape.

According to yet another aspect, a gap has uniform cell spacing.

According to still yet another aspect, a first and a fourth surface are each defined by a non-planar shape.

According to another aspect, a first and a second substrate each defines a uniform thickness.

According to yet another aspect, a second and a third surface each extends to an outer perimeter defining an area, respectively, and the non-planar shape defines at least 20% of the area.

According to still yet another aspect, a flexible conductive layer formed of poly(3,4-ethylenedioxythiophene) (“PEDOT”).

According to yet another aspect of the present disclosure, an electro-optic assembly includes a first substrate of a non-planar shape having a first surface and a second surface opposite the first surface. A second substrate has the non-planar shape and includes a third surface and a fourth surface opposite the third surface. The second and third surfaces face each other to define a gap. The second and third surfaces each extend to an outer perimeter defining an area, respectively, and a non-planar shape defines at least 20% of the area. A first electrode stack is coupled to the second surface, and a second electrode stack is coupled to the third surface. An electro-optic medium is located between the first electrode stack and the second electrode stack. At least one of the first and second electrode stacks includes a base layer, a conduction layer formed of a transparent conductive material, and a flexible conductive layer spaced from the base layer by the conduction layer. The flexible conductive layer is formed of an electrically conductive polymer.

According to another aspect, a flexible conductive layer is formed of a polythiophene.

According to yet another aspect, a base layer is formed of a polythiophene.

According to another aspect of the present disclosure, an electro-optic preform roll includes a substrate and an electrode stack coupled to the substrate. The electrode stack includes a base layer, a conduction layer formed of a transparent conductive material, and a flexible conductive layer spaced from the base layer by the conduction layer. The flexible conductive layer is formed of an electrically conductive polymer.

According to another aspect, the flexible conductive layer is formed of a polythiophene.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic assembly, comprising:
a first substrate having a first surface and a second surface opposite the first surface;
a second substrate having a third surface and a fourth surface opposite the third surface, the second and third surfaces facing each other to define a gap;
a first electrode stack coupled to the second surface;
a second electrode stack coupled to the third surface;
an electro-optic medium located between the first electrode stack and the second electrode stack; and
at least one of the first and second electrode stacks comprising:
a base layer;
a conduction layer formed of a transparent conductive material; and
a flexible conductive layer spaced from the base layer by the conduction layer, the flexible conductive layer formed of an electrically conductive polymer.

2. The electro-optic assembly of claim 1, wherein the flexible conductive layer is formed of a polythiophene.

3. The electro-optic assembly of claim 1, wherein the base layer is formed of a polythiophene.

4. The electro-optic assembly of claim 1, further including an adhesion layer disposed between the conduction layer and the flexible conductive layer.

5. The electro-optic assembly of claim 4, wherein the adhesion layer includes an oxide.

6. The electro-optic assembly of claim 1, wherein the base layer is conductive.

7. The electro-optic assembly of claim 1, wherein the base layer includes an insulating layer.

8. The electro-optic assembly of claim 1, wherein the first and second substrate are non-planar.

9. The electro-optic assembly of claim 1, wherein the conduction layer is sandwiched between a pair of adhesion layers that adhere and protect the conduction layer.

10. The electro-optic assembly of claim 9, wherein the pair of adhesion layers are formed of a metal oxide.

11. An electro-optic assembly, comprising:
a first substrate of a non-planar shape including a first surface and a second surface opposite the first surface;
a second substrate has the non-planar shape and includes a third surface and a fourth surface opposite the third surface, the second and third surfaces facing each other to define a gap;
a first electrode stack coupled to the second surface;
a second electrode stack coupled to the third surface;
an electro-optic medium located between the first electrode stack and the second electrode stack; and
the first and second electrode stacks comprising:
a base layer;
a conduction layer formed of a transparent conductive material; and
a flexible conductive layer spaced from the base layer by the conduction layer, the flexible conductive layer formed of a polythiophene.

12. The electro-optic assembly of claim 11, wherein the second and third surfaces are each defined by the non-planar shape.

13. The electro-optic assembly of claim 12, wherein the gap has uniform cell spacing.

14. The electro-optic assembly of claim 13, wherein the first and fourth surfaces are each defined by the non-planar shape.

15. The electro-optic assembly of claim 14, wherein the first and second substrates each define a uniform thickness.

16. The electro-optic assembly of claim 13, wherein the second and third surfaces each extend to an outer perimeter defining an area, respectively, and the non-planar shape defines at least 20% of the area.

17. The electro-optic assembly of claim 11, wherein the flexible conductive layer formed of poly(3,4-ethylenedioxythiophene) (“PEDOT”).

18. An electro-optic assembly, comprising:
a first substrate having a first surface and a second surface opposite the first surface;
a second substrate having a third surface and a fourth surface opposite the third surface, the second and third surfaces facing each other to define a gap with uniform cell spacing, and wherein the second and third surfaces each extend to an outer perimeter defining an area, respectively, and a non-planar shape defines at least 20% of the area;
a first electrode stack coupled to the second surface;
a second electrode stack coupled to the third surface;
an electro-optic medium located between the first electrode stack and the second electrode stack; and
at least one of the first and second electrode stacks comprising:
a base layer;
a conduction layer formed of a transparent conductive material; and
a flexible conductive layer spaced from the base layer by the conduction layer, the flexible conductive layer formed of an electrically conductive polymer.

19. The electro-optic assembly of claim 18, wherein the flexible conductive layer is formed of a polythiophene.

20. The electro-optic assembly of claim 19, wherein the base layer is formed of a polythiophene.
